(19) United States
(12) Patent Application Publication
(10) Pub. No.: US 2023/0315837 A1
(43) Pub. Date: Oct. 5, 2023

(54) INLINE FRAME CONTENT DATA MANAGEMENT SYSTEM

(71) Applicant: Toshiba Global Commerce Solutions, Inc., Durham, NC (US)

(72) Inventor: Bradley MARCHESSEAULT, Durham, NC (US)

(21) Appl. No.: 17/710,554

(22) Filed: Mar. 31, 2022

(51) Int. Cl. G06F 21/54

(52) U.S. Cl. CPC G06F 21/54; G06F 2221/033

(57) ABSTRACT

Systems and methods of managing browser data of inline frames presented on a web page in a browser are provided. In one exemplary embodiment, a method is performed by a browser data manager operationally coupled to a browser application executed on a computing device. Further, the browser application includes one or more inline frames presented on a web page in a browser for display. Each inline frame has a web application, and the browser data manager is configured to maintain a repository of data associated with content for each inline frame. The method includes sending, to a first web application of a first inline frame of the one or more inline frames, data associated with content for the first inline frame responsive to determining that an attribute related to that content has changed.

### BACKGROUND

A web page is typically stored as a hypertext document on a website server computing device and can be requested from the website server through a browser application executed by a client computing device. A website typically includes many web pages that are linked by embedded navigation elements such as hypertext links that enable navigation between web pages. Further, each web page is generally defined using a hypertext language such as hypertext markup language (HTML) or an extensible hypertext markup language (XML). A client computing device can request a certain web page from a website server through the browser application. In response, the website server will send that web page to the browser application of the requesting client computing device. The browser application will then render the web page and output the rendered web page for display. A hypertext document is typically represented by many hypertext elements. One of these hypertext elements is a frame element that is used to divide a web page into multiple sections with each section capable of loading content independently. Further, the hypertext or media elements displayed in a frame may originate from different web sites. Another hypertext element is an inline frame element that is used to embed another hypertext document within the current hypertext document. An HTML IFrame is an HTML inline frame element that enables a frame to be embedded in the body of an HTML document. Further, HTML IFrames loaded on a web page are capable of holding HTML documents downloaded from different website servers. In this case, for security reasons, browser applications block any communication between HTML IFrames loaded on a web page.

### BRIEF DESCRIPTION OF THE DRAWINGS

The present disclosure will now be described more fully hereinafter with reference to the accompanying drawings, in which embodiments of the disclosure are shown. However, this disclosure should not be construed as limited to the embodiments set forth herein. Rather, these embodiments are provided so that this disclosure will be thorough and complete, and will fully convey the scope of the disclosure to those skilled in the art. Like numbers refer to like elements throughout.

FIG. 1 illustrates one embodiment of a system of managing data of an inline frame on a web page of a browser in accordance with various aspects as described herein.

FIG. 2A illustrates one embodiment of a browser data manager in accordance with various aspects as described herein. FIG. 2B illustrates one embodiment of a computing device in accordance with various aspects as described herein.

FIGS. 3A-B illustrate other embodiments of a browser data manager device in accordance with various aspects as described herein. FIGS. 3C-D illustrate other embodiments of a computing device in accordance with various aspects as described herein.

FIG. 4A illustrates one embodiments of a method performed by a browser data manager of managing data of an inline frame on a web page of a browser in accordance with various aspects as described herein. FIG. 4B illustrates one embodiment of a method performed by a computing device of managing data of an inline frame on a web page of a browser in accordance with various aspects as described herein.

FIG. 5 illustrates other embodiments of a computing device and a browser data manager device in accordance with various aspects as described herein.

### DETAILED DESCRIPTION

For simplicity and illustrative purposes, the present disclosure is described by referring mainly to an exemplary embodiment thereof. In the following description, numerous specific details are set forth in order to provide a thorough understanding of the present disclosure. However, it will be readily apparent to one of ordinary skill in the art that the present disclosure may be practiced without limitation to these specific details.

Web applications of inline frames (e.g., HTML IFrame, XML XFrame) presented on a web page in a browser for display by a browser application should be able to share common, single sourced data within the browser application. Currently, browser applications only allow such sharing if the uniform resource locator (URL) of each inline frame is downloaded from the same domain and as such, each inline frame typically must duplicate the content data. Further, a browser application may contain two or more child inline frames that provide all or a portion of the browser application functionality. Each child inline frame contains an individual web application (visible or hidden on the corresponding web page) that provides a portion of the overall browser application. Content data for the browser application is typically only processed by the browser application and as such, is not made available to the child inline frame applications unless the content data is specifically sent to a certain child inline frame application or shared by a network server. This scheme is problematic since the content data is duplicated in each child inline frame application and no single source of the content data exists without requiring the child inline frame applications to always obtain their content data from the browser application. Accordingly, the improvements described herein include a common data service or manager available to all inline frame applications (regardless of their origin or domain) enabling each inline frame application to create, delete, or monitor properties or attributes associated with content data through the data service or manager.

In one exemplary embodiment, a data service/manager application is loaded into the browser application or into a child inline frame. The browser application can then use the data service/manager application as the data repository associated with content for the child inline frame. Each of the other child inline frame applications can register/request to monitor and react to property/attribute changes of content associated with that inline frame. The data service/manager application provides a single source for content data and reduces content data duplication across the child inline frame applications. In one example, a point of sale (PoS) system can use these improvements to have the data service/manager application monitor sales order data associated with an inline frame application and then notify that online frame application when the sales order data is changed or modified. Further, other inline frame applications may have access to this data through the data service/manager application.

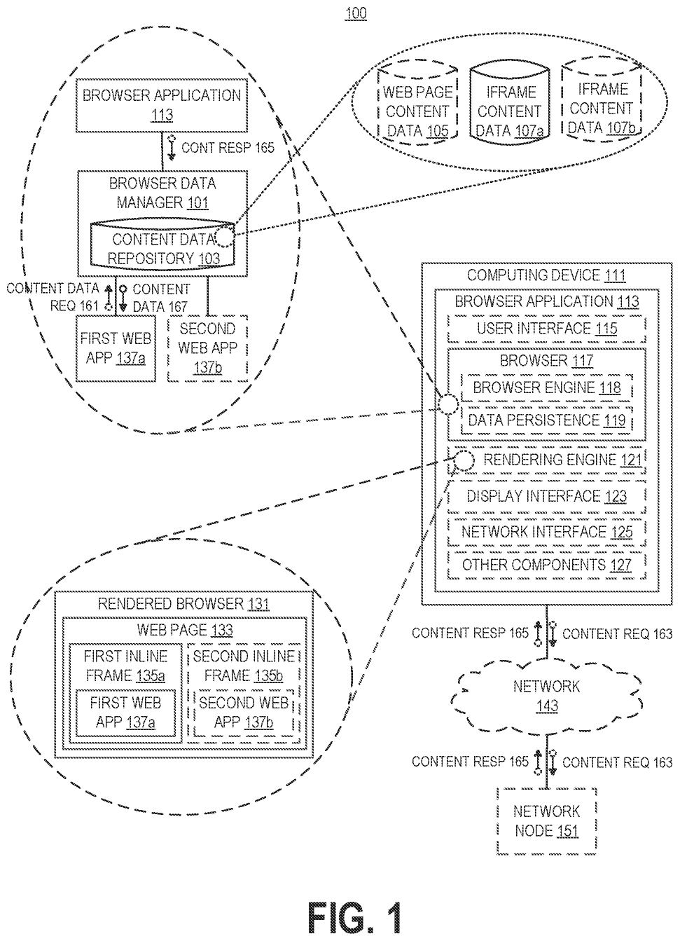

In this disclosure, systems and methods of managing content data associated with an inline frame presented on a web page in a browser are provided. Further, the systems and methods of the present disclosure include a common data service/manager for one or more inline frame applications such as those concurrently loaded onto a single web page by a browser application. For example, FIG. 1 illustrates one embodiment of a system 100 of managing data of content associated with an inline frame 135a-b on a web page 133 in a rendered browser 131 in accordance with various aspects as described herein. In one definition, an inline frame is an embedded element of a web page. In another definition, an inline frame is an embedded element of a document displayed in a web browser. In yet another definition, an inline frame enables content of one hypertext document to be embedded in another hypertext document. In FIG. 1, the system 100a can include a browser data manager device 101 operationally coupled to a browser application 113 of a computing device 111. Additionally or alternatively, in FIG. 1, the system 100 includes the computing device 111 having the browser application 113 and the browser data manager 101 integrated with the browser application 113 of the computing device 111. For example, the browser data manager 101 can be implemented as a circuit separate from the browser application 113. In another example, the browser data manager 101 can be implemented as a circuit integrated with the browser application 113. In yet another example, the browser data manager 101 can be implemented as a module of the browser application 113 that is executed in the same or different process of the browser application 113. In a further example, the browser data manager 101 can be implemented as a web application in an inline frame of a web page.

In FIG. 1, the browser application 113 can include a user interface 115, a browser 117, a rendering engine 121, a display interface 123, a network interface 125, another component 127, the like, or any combination thereof. Further, the browser application 113 can be implemented using a single process or multiple processes executed by the computing device 111. For a multi-process architecture, all or any combination of components, elements, extensions, web applications, frames, inline frames, or the like can be executed in separate processes. In one example, each web page or browser tab has its own process executed by the computing device 111. In another example, each frame or inline frame has its own process executed by the computing device 111. In yet another example, each web application has its own process executed by the computing device 111. A web application can include one or more of the following applications: online office suite, photo sharing, video streaming, music streaming, bibliographic database, mapping, publication management, document management, blogging application, distributed social network, social news, social aggregation, social bookmarking, translation, homepage, virtual world, virtual web hosting application, web mail application, file sharing, password manager, web chat, web calendar, online file editing application, virtual machine provisioning application, word processor, spreadsheet, presentation application, project management application, video conferencing, computer-aided design application, video editing application, point-of-sale application, or the like. The user interface 115 is configured to manage the interaction between the browser 117 and user data (e.g., keyboard data, mouse data) communicated with the browser 117 through the computing device 111. The user interface 115 can be configured to includes a top bar in the rendered browser 131 for entering a URL address. Further, the user interface 115 can be configured to include tabs, setting options, forward/backwards indicators, or the like.

In FIG. 1, the browser 117 includes a browser engine 118 and data persistence 119. The browser engine 118 is configured to query and control the rendering engine 121 based on inputs received from the user interface 115, network interface 125, or other components 127 of the browser application 113. The data persistence 119 is configured to provide storage mechanisms for the browser 117 such as for local storage, global storage, database storage, file system storage, or the like. Further, the data persistence 119 is configured to manage user data such as a cache, cookies, bookmarks, preferences, or the like. The rendering engine 121 is configured to render content on a display such as by loading a web page, parsing files (e.g., HTML files), applying styles (e.g., cascading style sheets (CSS)), constructing frames and inline frames (e.g., HTML frame, HTML iFrame, XML XFrame), painting frames, the like, or any combination thereof. As shown in FIG. 1, the browser engine 118 queries and controls the rendering engine 121 to output for display the rendered browser 131 having the rendered web page 133 with the first and second inline frames 135a-b and corresponding web applications 137a-b. The display interface 123 is configured to provide drawing and windowing primitives, user interface widgets, fonts, or the like. The network interface 125 is configured to fetch data and handle resources related to a network node 151 (e.g., web server) (e.g., LAN, WAN, Internet). The other components 127 may include a script interpreter (e.g., JavaScript) for reading and executing scripts and handling the result with the rendering engine 121, an XML parser, a display backend, a database manager, the like, or any combination thereof.

In operation, the first web application 137a of the first inline frame 135a sends, to the browser data manager 101, an indication that requests data associated with the content 107a of the first inline frame 135a such as in response to an attribute of the content 107a of the first inline frame 135a having changed. The browser data manager 101 receives the request 161 and in response, monitors for a change in the attribute of the content 107a of the first inline frame 135a. The browser application 113 sends, to the network node 151 (e.g. HTML web server), a content request (e.g., HTML request) 163 for data associated with the content 107a (e.g., text, image, audio, animation, video, document, e-services, software data or applications, web pages, e-mail messages) of the first inline frame 135a. In response, the browser application 113 receives, from the network node 151, content response 165 (e.g., HTML response) that includes the data associated with the content 107a of the first inline frame 135a. The browser application 113 then forwards, to the browser data manager 10, the content response 165 associated with the content 107a of the first inline frame 135a.

In the current embodiment, the browser data manager 101 receives the content response 165 and determines that the received data associated with the content 107a of the first inline frame 135a is different from data stored in the repository 103 that is associated with the content 107a of the first inline frame 135a. In response, the browser data manager 101 modifies an attribute associated with the content 107a of the first inline frame 135a to indicate that the data of such content has changed and as such, stores in the repository 103 the received data associated with the content 107a of the first inline frame 135a. In one definition, an attribute is information associated with content. In another definition, an attribute is metadata such as descriptive metadata (e.g., title, abstract, author, keywords), structural metadata (e.g., version), administrative metadata (e.g., content type, permissions, creation or modification date), reference metadata (e.g., content quality), statistical metadata, legal metadata (e.g., creator, copyright holder, public licensing), the like, or any combination thereof. In one example, an attribute can include: changed content indication, removed or deleted content indication, new content indication, means of the creation of the content, purpose of the content, time or date of creation or modification of the content, creator or author of the content, location on a network where the content was created, file size of the content, content quality, source of the content, process used to create the content, the like, or any combination thereof. The browser data manager 101 then sends, to the first web application 137a of the first inline frame 135a, the data 167 associated with the content 107a of the first inline frame 135a responsive to determining that the attribute related to that content 107a has changed. The first web application 137a of the first inline frame 135a receives the data 165 associated with the content 107a of the first inline frame 135a.

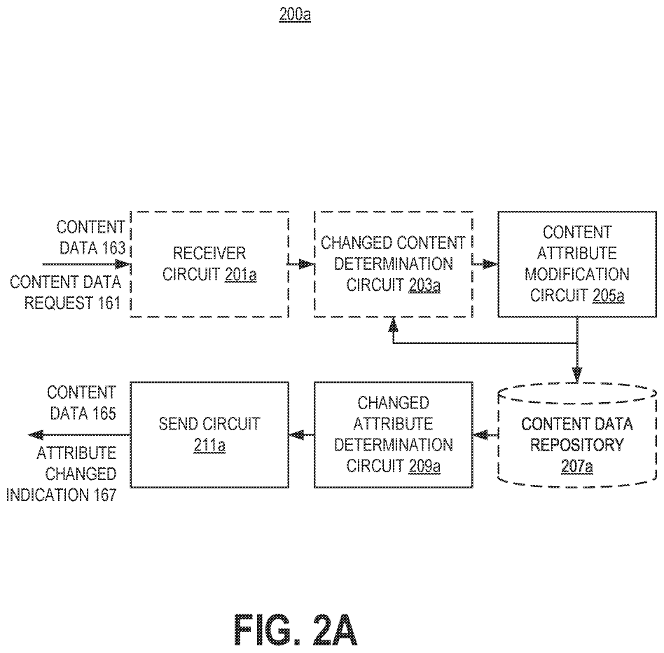

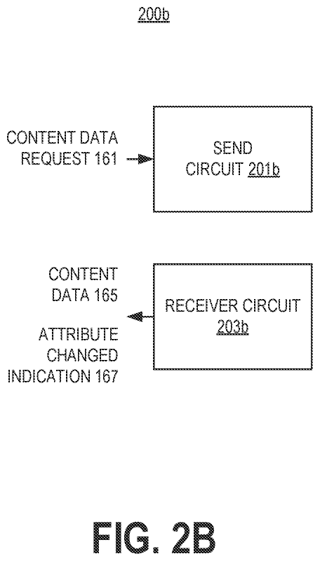

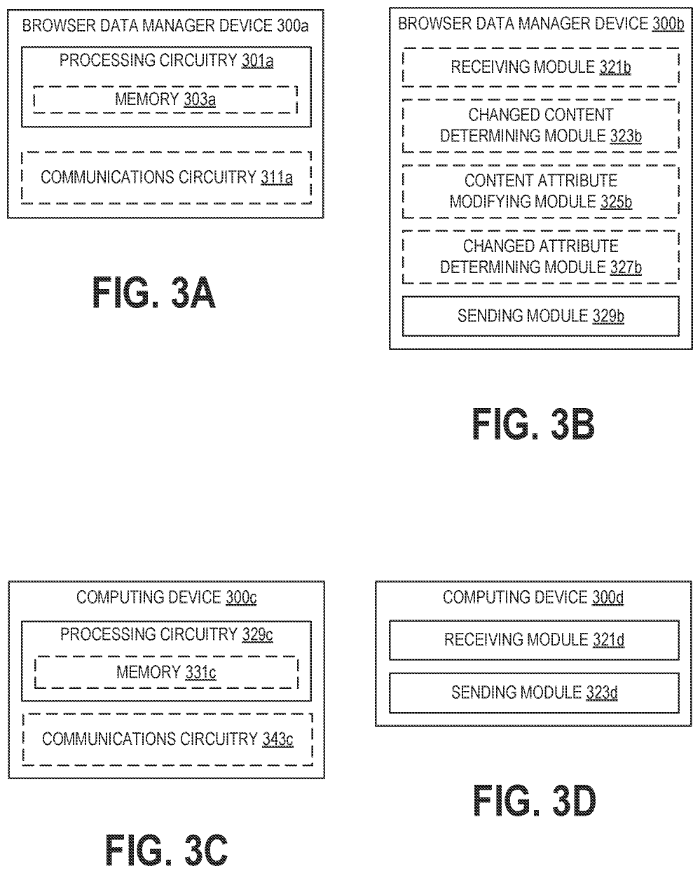

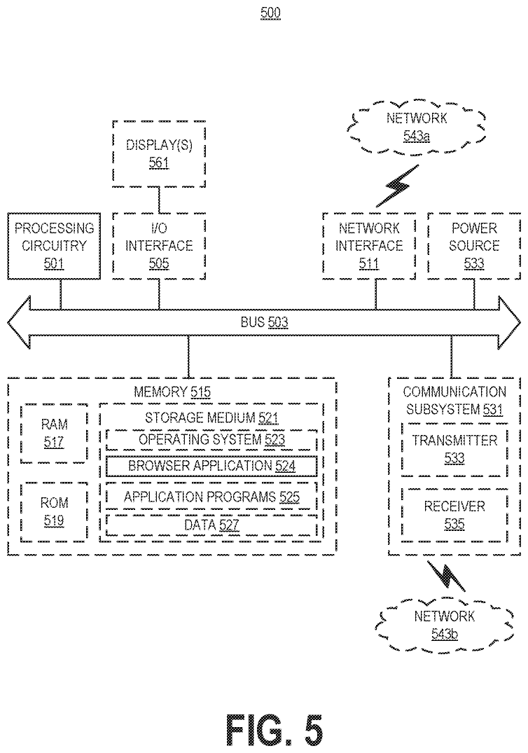

FIG. 2A illustrates one embodiment of a browser data manager 200a in accordance with various aspects as described herein. In FIG. 2A, the device 200a implements various functional means, units, or modules (e.g., via the processing circuitry 301a in FIG. 3A, via the processing circuitry 501 in FIG. 5, via software code, or the like), or circuits. In one embodiment, these functional means, units, modules, or circuits (e.g., for implementing the method(s) herein) may include for instance: a receiver circuit 201a operable to receive, from the browser application, data associated with content for a first inline frame of the one or more inline frames; a changed content determination circuit 203a operable to determine that the received data associated with the content for the first inline frame is different from data stored in a repository 207a that is associated with the content for the first inline frame; a content attribute modification circuit 205a operable to modify an attribute associated with the content for the first inline frame; a changed attribute determination circuit 209a operable to determine that the attribute related to that content has changed; and a send circuit 211a operable to send, to the first web application of the first inline frame, the received data associated with the content for the first inline frame.

FIG. 2B illustrates one embodiment of a computing device 200b in accordance with various aspects as described herein. In FIG. 2B, the device 200b implements various functional means, units, or modules (e.g., via the processing circuitry 301c in FIG. 3C, via the processing circuitry 501 in FIG. 5, via software code, or the like), or circuits. In one embodiment, these functional means, units, modules, or circuits (e.g., for implementing the method(s) herein) may include for instance: a send circuit 201b operable to send, by a first web application of a first inline frame of the one or more inline frames, to the browser data manager, an indication that requests data associated with the content for the first inline frame; and a receiver circuit 203b operable to receive, by the first web application of the first inline frame, from the browser data manager, the data associated with the content for the first inline frame responsive to determining that the attribute related to that content has changed.

FIGS. 3A-B illustrate other embodiments of a browser data manager device 300a-b in accordance with various aspects as described herein. In FIG. 3A, the device 300a may include processing circuitry 301a that is operably coupled to memory 303a, communications circuitry 311a, the like, or any combination thereof. The communication circuitry 311a is configured to transmit and/or receive information to and/or from one or more other nodes via any communication technology. The processing circuitry 301a is configured to perform processing described herein, such as by executing instructions stored in memory 303a. The processing circuitry 303a in this regard may implement certain functional means, units, or modules.

In FIG. 3B, the browser data manager 300b implements various functional means, units, or modules (e.g., via the processing circuitry 301a in FIG. 3A, via the processing circuitry 501 in FIG. 5, via software code, or the like). In one embodiment, these functional means, units, or modules (e.g., for implementing the method(s) described herein) may include for instance: a receiving module 321b for receiving, from the browser application, data associated with content for a first inline frame of the one or more inline frames; a changed content determining module 323b for determining that the received data associated with the content for the first inline frame is different from data stored in a repository that is associated with the content for the first inline frame; a content attribute modifying module 325b for modifying an attribute associated with the content for the first inline frame; a changed attribute determining module 327b for determining that the attribute related to that content has changed; and a sending module 329b for sending, to the first web application of the first inline frame, the received data associated with the content for the first inline frame.

FIGS. 3C-D illustrate other embodiments of a computing device 300c-d in accordance with various aspects as described herein. In FIG. 3C, the device 300c may include processing circuitry 301c that is operably coupled to memory 303c, communications circuitry 311c, the like, or any combination thereof. The communication circuitry 311c is configured to transmit and/or receive information to and/or from one or more other nodes via any communication technology. The processing circuitry 301c is configured to perform processing described herein, such as by executing instructions stored in memory 303c. The processing circuitry 303c in this regard may implement certain functional means, units, or modules.

In FIG. 3D, the browser data manager 300d implements various functional means, units, or modules (e.g., via the processing circuitry 301c in FIG. 3C, via the processing circuitry 501 in FIG. 5, via software code, or the like). In one embodiment, these functional means, units, or modules (e.g., for implementing the method(s) described herein) may include for instance: a sending module 321d for sending, by a first web application of a first inline frame of the one or more inline frames, to the browser data manager, an indication that requests data associated with the content for the first inline frame; and a receiving module 323d for receiving, by the first web application of the first inline frame, from the browser data manager, the data associated with the content for the first inline frame responsive to determining that the attribute related to that content has changed.

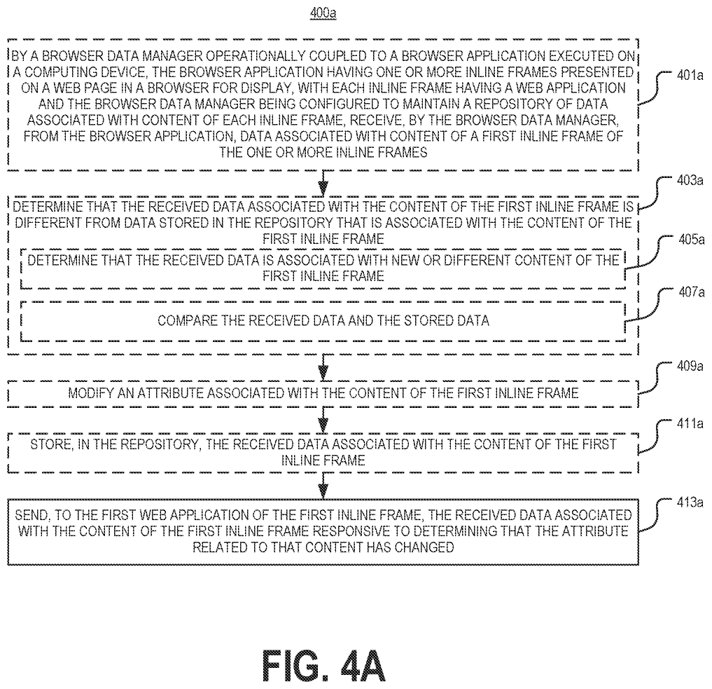

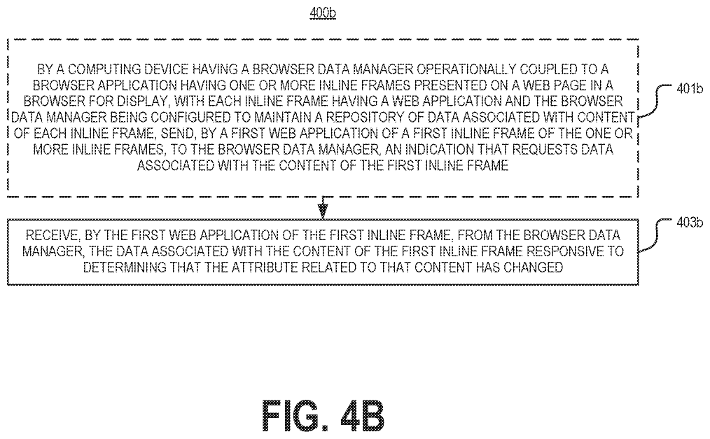

FIG. 4A illustrates one embodiments of a method 400a performed by a browser data manager 101, 200a, 300a-b, 500 of managing data of an inline frame on a web page of a browser in accordance with various aspects as described herein. In FIG. 4A, the method 400a may include receiving, by the browser data manager, from a browser application, data associated with content for a first inline frame of the one or more inline frames, as represented by block 401a. At block 403a, the method 400a may include determining that the received data associated with the content for the first inline frame is different from data stored in the repository that is associated with the content for the first inline frame. At block 405a, the step of determining that the received data is different from the store data may include determining that the received data is associated with new content for the first inline frame. At block 407a, the step of determining that the received data is different from the store data may include comparing the received data and the stored data. At block 409a, the method 400a may include modifying an attribute associated with the content for the first inline frame responsive to determining that the received data is different from the stored data. Further, the method 400a may include storing, in the repository, the received data associated with the content for the first inline frame, as represented by block 411a. At block 413a, the method includes sending, to the first web application of the first inline frame, the received data associated with the content for the first inline frame responsive to determining that the attribute related to that content has changed.

FIG. 4B illustrates one embodiment of a method 400b performed by a computing device 111, 200b, 300c-d, 500 of managing data of an inline frame on a web page of a browser in accordance with various aspects as described herein. In FIG. 4B, the method 400b may include sending, by a first web application of a first inline frame of one or more inline frames, to a browser data manager, an indication that requests data associated with content for a first inline frame, as represented by block 401b. At block 403b, the method 400b includes receiving, by the first web application of the first inline frame, from the browser data manager, the data associated with the content for the first inline frame responsive to determining that the attribute related to that content has changed.

FIG. 5 illustrates another embodiment of a computing device and a browser data manager device 500 in accordance with various aspects as described herein. In FIG. 5, device 500 includes processing circuitry 501 that is operatively coupled to input/output interface 505, network connection interface 511, memory 515 including random access memory (RAM) 517, read-only memory (ROM) 519, and storage medium 521 or the like, communication subsystem 531, power source 533, and/or any other component, or any combination thereof. The input/output interface 505 may be configured to provide a communication interface to an input device, output device, or input and output device. The device 500 may be configured to use an output device via input/output interface 505. An output device may use the same type of interface port as an input device. For example, a USB port may be used to provide input to and output from the device 500. The output device may be a speaker, a sound card, a video card, a display 561, a monitor, a printer, an actuator, an emitter, a smartcard, another output device, or any combination thereof. The device 500 may be configured to use an input device via input/output interface 505 to allow a user to capture information into the device 500. The input device may include a touch-sensitive or presence-sensitive display, an image sensor, (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical or image sensor, an infrared sensor, a proximity sensor, another like sensor, or any combination thereof.

In FIG. 5, storage medium 521 may include operating system 523, application program 525, data 527, the like, or any combination thereof. In other embodiments, storage medium 521 may include other similar types of information. Certain devices may utilize all of the components shown in FIG. 5, or only a subset of the components. The level of integration between the components may vary from one device to another device. Further, certain devices may contain multiple instances of a component, such as multiple processors, memories, neural networks, network connection interfaces, transceivers, etc.

In FIG. 5, processing circuitry 501 may be configured to process computer instructions and data. Processing circuitry 501 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 501 may include two central processing units (CPUs). Data may be information in a form suitable for use by a computer.

In FIG. 5, the network connection interface 511 may be configured to provide a communication interface to network 543a. The network 543a may encompass wired and/or wireless networks such as a local-area network (LAN), a wide-area network (WAN), a computer network, a wireless network, a telecommunications network, another like network or any combination thereof. For example, network 543a may comprise a Wi-Fi network. The network connection interface 511 may be configured to include a receiver and a transmitter interface used to communicate with one or more other devices over a communication network according to one or more communication protocols, such as Ethernet, TCP/IP, SONET, ATM, or the like. The network connection interface 511 may implement receiver and transmitter functionality appropriate to the communication network links (e.g., optical, electrical, and the like). The transmitter and receiver functions may share circuit components, software or firmware, or alternatively may be implemented separately.

The RAM 517 may be configured to interface via a bus 503 to the processing circuitry 501 to provide storage or caching of data or computer instructions during the execution of software programs such as the operating system, application programs, and device drivers. The ROM 519 may be configured to provide computer instructions or data to processing circuitry 501. For example, the ROM 519 may be configured to store invariant low-level system code or data for basic system functions such as basic input and output (I/O), startup, or reception of keystrokes from a keyboard that are stored in a non-volatile memory. The storage medium 521 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, the storage medium 521 may be configured to include an operating system 523, an application program 525 such as web browser, web application, user interface, browser data manager as described herein, a widget or gadget engine, or another application, and a data file 527. The storage medium 521 may store, for use by the device 500, any of a variety of various operating systems or combinations of operating systems.

The storage medium 521 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. The storage medium 521 may allow the device 500a-b to access computer-executable instructions, application programs or the like, stored on transitory or non-transitory memory media, to off-load data, or to upload data. An article of manufacture, such as one utilizing a communication system may be tangibly embodied in the storage medium 521, which may comprise a device readable medium.

The processing circuitry 501 may be configured to communicate with network 543b using the communication subsystem 531. The network 543a and the network 543b may be the same network or networks or different network or networks. The communication subsystem 531 may be configured to include one or more transceivers used to communicate with the network 543b. For example, the communication subsystem 531 may be configured to include one or more transceivers used to communicate with one or more remote transceivers of another device capable of wireless communication according to one or more communication protocols, such as IEEE 802.11, CDMA, WCDMA, GSM, LTE, UTRAN, WiMax, or the like. Each transceiver may include transmitter 533 and/or receiver 535 to implement transmitter or receiver functionality, respectively, appropriate to the RAN links (e.g., frequency allocations and the like). Further, transmitter 533 and receiver 535 of each transceiver may share circuit components, software, or firmware, or alternatively may be implemented separately.

In FIG. 5, the communication functions of the communication subsystem 531 may include data communication, voice communication, multimedia communication, short-range communications such as Bluetooth, near-field communication, location-based communication such as the use of the global positioning system (GPS) to determine a location, another like communication function, or any combination thereof. For example, the communication subsystem 531 may include cellular communication, Wi-Fi communication, Bluetooth communication, and GPS communication. The network 543b may encompass wired and/or wireless networks such as a local-area network (LAN), a wide-area network (WAN), a computer network, a wireless network, a telecommunications network, another like network or any combination thereof. For example, the network 543b may be a cellular network, a Wi-Fi network, and/or a near-field network. The power source 513 may be configured to provide alternating current (AC) or direct current (DC) power to components of the device 500a-b.

The features, benefits and/or functions described herein may be implemented in one of the components of the device 500 or partitioned across multiple components of the device 500. Further, the features, benefits, and/or functions described herein may be implemented in any combination of hardware, software, or firmware. In one example, communication subsystem 531 may be configured to include any of the components described herein. Further, the processing circuitry 501 may be configured to communicate with any of such components over the bus 503. In another example, any of such components may be represented by program instructions stored in memory that when executed by the processing circuitry 501 perform the corresponding functions described herein. In another example, the functionality of any of such components may be partitioned between the processing circuitry 501 and the communication subsystem 531. In another example, the non-computationally intensive functions of any of such components may be implemented in software or firmware and the computationally intensive functions may be implemented in hardware.

Those skilled in the art will also appreciate that embodiments herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

Additional embodiments will now be described. At least some of these embodiments may be described as applicable in certain contexts for illustrative purposes, but the embodiments are similarly applicable in other contexts not explicitly described.

In one exemplary embodiment, a method is performed by a browser data manager operationally coupled to a browser application executed on a computing device. Further, the browser application has one or more inline frames presented on a web page in a browser for display. Each inline frame has a web application. In addition, the browser data manager is configured to maintain a repository of data associated with content for each inline frame. The method includes sending, to a first web application of a first inline frame of the one or more inline frames, data associated with content for the first inline frame responsive to determining that an attribute related to that content has changed.

In another exemplary embodiment, the method further includes receiving, by the browser data manager, from the browser application, the data associated with the content for the first inline frame.

In another exemplary embodiment, the method further includes modifying an attribute associated with the content for the first inline frame responsive to determining that the received data associated with the content for the first inline frame is different from data stored in the repository that is associated with the content for the first inline frame.

In another exemplary embodiment, the method further includes storing, in the repository, the received data associated with the content for the first inline frame.

In another exemplary embodiment, the step of determining that the received data is different from the stored data further includes determining that the received data is associated with new or different content for the first inline frame.

In another exemplary embodiment, the step of determining that the received data is different from the stored data further includes comparing the received data and the stored data.

In another exemplary embodiment, the method further includes receiving, by the browser data manager, from the first web application, an indication that requests data associated with the content for the first inline frame. Further, the step of sending the data to the first web application of the first inline frame is further responsive to receiving the request indication.

In another exemplary embodiment, the method further includes receiving, by the browser data manager, from the first web application, an indication that requests data associated with the content for the first inline frame when the attribute associated with the content for the first inline frame is changed.

In another exemplary embodiment, the step of sending the data to the first web application of the first inline frame is further responsive to receiving the request indication.

In another exemplary embodiment, the method further includes sending, by the browser data manager, to the first web application, an indication that the data associated with the content for the first inline frame changed responsive to determining that the attribute associated with the content for the first inline frame changed.

In another exemplary embodiment, the method further includes receiving, by the browser data manager, from the first web application, an indication that requests data associated with a certain portion of the content for the first inline frame when the attribute associated with that content for the first inline frame is changed.

In another exemplary embodiment, the method further includes sending, to the first web application, the requested data responsive to determining that the attribute associated with the certain portion of the content for the first inline frame changed.

In another exemplary embodiment, the method further includes sending, to a second web application of a second inline frame of the one or more inline frames, data associated with content for the second inline frame responsive to determining that an attribute related to that content has changed.

In another exemplary embodiment, the browser application is configured to load each inline frame on the web page in the browser, with each inline frame being associated with a different uniform resource locator (URL).

In another exemplary embodiment, the browser data manager is configured as a third web application loaded into a third inline frame on the web page of the browser application.

In another exemplary embodiment, the browser data manager is operationally coupled to the web application of each inline frame on the web page through a fourth web application of the browser application, with the fourth web application being configured to load the first web application into the first inline frame on the web page and load the browser data manager as the third web application into the third inline frame on the web page of the browser application.

In another exemplary embodiment, the browser application includes the browser data manager.

In another exemplary embodiment, the repository includes data associated with content for the web page.

In one exemplary embodiment, a browser data manager includes processing circuitry and a memory having a repository of data associated with content for one or more inline frames presented on a web page in a browser for display by a browser application. Further, each inline frame includes a web application. The memory also includes instructions executable by the processing circuitry whereby the processing circuitry is configured to send, to a first web application of a first inline frame of the one or more inline frames, data associated with content for the first inline frame responsive to determining that an attribute related to that content has changed.

In one exemplary embodiment, a method is performed by a computing device having a browser data manager operationally coupled to a browser application with one or more inline frames presented on a web page in a browser for display. Further, each inline frame has a web application, and the browser data manager is configured to maintain a repository of data associated with content for each inline frame. The method includes receiving, by a first web application of a first inline frame of the one or more inline frames, data associated with content for the first inline frame responsive to an attribute related to that content being changed.

In one exemplary embodiment, a computing device includes processing circuitry and a memory, with the memory comprising instructions executable by the processing circuitry whereby the processing circuitry is configured to receive, by a first web application of a first inline frame of one or more inline frames presented on a web page in a browser for display by a browser application, from a browser data manager that is operationally coupled to the browser application, data associated with content for the first inline frame responsive to an attribute related to that content being changed. Further, each inline frame has a web application, and the browser data manager is configured to maintain a repository of data associated with content for each inline frame.

The previous detailed description is merely illustrative in nature and is not intended to limit the present disclosure, or the application and uses of the present disclosure. Furthermore, there is no intention to be bound by any expressed or implied theory presented in the preceding field of use, background, summary, or detailed description. The present disclosure provides various examples, embodiments and the like, which may be described herein in terms of functional or logical block elements. The various aspects described herein are presented as methods, devices (or apparatus), systems, or articles of manufacture that may include a number of components, elements, members, modules, nodes, peripherals, or the like. Further, these methods, devices, systems, or articles of manufacture may include or not include additional components, elements, members, modules, nodes, peripherals, or the like.

Furthermore, the various aspects described herein may be implemented using standard programming or engineering techniques to produce software, firmware, hardware (e.g., circuits), or any combination thereof to control a computing device to implement the disclosed subject matter. It will be appreciated that some embodiments may be comprised of one or more generic or specialized processors such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the methods, devices and systems described herein. Alternatively, some or all functions could be implemented by a state machine that has no stored program instructions, or in one or more application specific integrated circuits (ASICs), in which each function or some combinations of certain of the functions are implemented as custom logic circuits. Of course, a combination of the two approaches may be used. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The term “article of manufacture” as used herein is intended to encompass a computer program accessible from any computing device, carrier, or media. For example, a computer-readable medium may include: a magnetic storage device such as a hard disk, a floppy disk or a magnetic strip; an optical disk such as a compact disk (CD) or digital versatile disk (DVD); a smart card; and a flash memory device such as a card, stick or key drive. Additionally, it should be appreciated that a carrier wave may be employed to carry computer-readable electronic data including those used in transmitting and receiving electronic data such as electronic mail (e-mail) or in accessing a computer network such as the Internet or a local area network (LAN). Of course, a person of ordinary skill in the art will recognize many modifications may be made to this configuration without departing from the scope or spirit of the subject matter of this disclosure.

Throughout the specification and the embodiments, the following terms take at least the meanings explicitly associated herein, unless the context clearly dictates otherwise. Relational terms such as “first” and “second,” and the like may be used solely to distinguish one entity or action from another entity or action without necessarily requiring or implying any actual such relationship or order between such entities or actions. The term “or” is intended to mean an inclusive “or” unless specified otherwise or clear from the context to be directed to an exclusive form. Further, the terms “a,” “an,” and “the” are intended to mean one or more unless specified otherwise or clear from the context to be directed to a singular form. The term “include” and its various forms are intended to mean including but not limited to. References to “one embodiment,” “an embodiment,” “example embodiment,” “various embodiments,” and other like terms indicate that the embodiments of the disclosed technology so described may include a particular function, feature, structure, or characteristic, but not every embodiment necessarily includes the particular function, feature, structure, or characteristic. Further, repeated use of the phrase “in one embodiment” does not necessarily refer to the same embodiment, although it may. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. A device or structure that is “configured” in a certain way is configured in at least that way, but may also be configured in ways that are not listed.

What is claimed is:

1. A method, comprising:
by a browser data manager operationally coupled to a browser application executed on a computing device, the browser application having one or more inline frames presented on a web page in a browser for display, with each inline frame having a web application and the browser data manager being configured to maintain a repository of data associated with content for each inline frame, sending, to a first web application of a first inline frame of the one or more inline frames, data associated with content for the first inline frame responsive to determining that an attribute related to that content has changed.

2. The method of claim 1, further comprising:
receiving, by the browser data manager, from the browser application, the data associated with the content for the first inline frame.

3. The method of claim 2, further comprising:
modifying an attribute associated with the content for the first inline frame responsive to determining that the received data associated with the content for the first inline frame is different from data stored in the repository that is associated with the content for the first inline frame.

4. The method of claim 3, further comprising:
storing, in the repository, the received data associated with the content for the first inline frame.

5. The method of claim 3, wherein the determining that the received data is different from the stored data further includes determining that the received data is associated with new or different content for the first inline frame.

6. The method of claim 3, wherein the determining that the received data is different from the stored data further includes comparing the received data and the stored data.

7. The method of claim 1, further comprising:
receiving, by the browser data manager, from the first web application, an indication that requests data associated with the content for the first inline frame.

8. The method of claim 7, wherein the sending the data is further responsive to receiving the request indication.

9. The method of claim 1, further comprising:
receiving, by the browser data manager, from the first web application, an indication that requests data associated with the content for the first inline frame when the attribute associated with the content for the first inline frame is changed.

10. The method of claim 7, wherein the sending the data is further responsive to receiving the request indication.

11. The method of claim 1, further comprising:
sending, by the browser data manager, to the first web application, an indication that the data associated with the content for the first inline frame changed responsive to determining that the attribute associated with the content for the first inline frame changed.

12. The method of claim 1, further comprising:
receiving, by the browser data manager, from the first web application, an indication that requests data associated with a certain portion of the content for the first inline frame when the attribute associated with that content for the first inline frame is changed.

13. The method of claim 12, further comprising:
sending, to the first web application, the requested data responsive to determining that the attribute associated with the certain portion of the content for the first inline frame changed.

14. The method of claim 1, further comprising:
sending, to a second web application of a second inline frame of the one or more inline frames, data associated with content for the second inline frame responsive to determining that an attribute related to that content has changed.

15. The method of claim 1, wherein the browser application is configured to load each inline frame on the web page in the browser, with each inline frame being associated with a different uniform resource locator (URL).

16. The method of claim 1, wherein the browser data manager is configured as a third web application loaded into a third inline frame on the web page of the browser application.

17. The method of claim 16, wherein the browser data manager is operationally coupled to the web application of each inline frame on the web page through a fourth web application of the browser application, with the fourth web application being configured to load the first web application into the first inline frame on the web page and load the browser data manager as the third web application into the third inline frame on the web page of the browser application.

18. A browser data manager, comprising:
processing circuitry and a memory having a repository of data associated with content for one or more inline frames presented on a web page in a browser for display by a browser application, with each inline frame having a web application, the memory further including instructions executable by the processing circuitry whereby the processing circuitry is configured to:
send, to a first web application of a first inline frame of the one or more inline frames, data associated with content for the first inline frame responsive to determining that an attribute related to that content has changed.

19. A method, comprising:
by a computing device having a browser data manager operationally coupled to a browser application with one or more inline frames presented on a web page in a browser for display, each inline frame having a web application and the browser data manager being configured to maintain a repository of data associated with content for each inline frame, receiving, by a first web application of a first inline frame of the one or more inline frames, data associated with content for the first inline frame responsive to an attribute related to that content being changed.

20. A computing device, comprising:
processing circuitry and a memory, the memory comprising instructions executable by the processing circuitry whereby the processing circuitry is configured to:
receive, by a first web application of a first inline frame of one or more inline frames presented on a web page in a browser for display by a browser application, from a browser data manager operationally coupled to the browser application, data associated with content for the first inline frame responsive to an attribute related to that content being changed, with each inline frame having a web application and the browser data manager being configured to maintain a repository of data associated with content for each inline frame.
